(19) United States
(12) Patent Application Publication
(10) Pub. No.: US 2009/0072682 A1
(43) Pub. Date: Mar. 19, 2009

(54) Protective boot for an electronic device

(75) Inventors: Durval Ribeiro, Owatonna, MN (US); Phillip McGee, Owatonna, MN (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: SPX Corporation

(21) Appl. No.: 11/902,117

(22) Filed: Sep. 19, 2007

(51) Int. Cl. A47B 81/00; B23P 19/00

(52) U.S. Cl. 312/223.2; 29/700

(57) ABSTRACT

A protective boot that protects a vehicle diagnostic device from damaging a vehicle to which is attached. The protective boot also helps to prevent the diagnostic device from being damaged when dropped from a distance off of the floor. The protective boot includes strap receiving members at various locations on the housing of the protective boot so that strapping members can be fed therethrough to attach the diagnostic device to the vehicle, such as a motorcycle. The protective boot also includes openings for access to controls or connections of the diagnostic device.

### FIELD OF THE INVENTION

The present invention relates generally to a protective cover. More particularly, the present invention relates to a protective boot for an electronic device.

### BACKGROUND OF THE INVENTION

Electronic diagnostic devices are used to diagnose a problem with a vehicle, such as a motorcycle. The electronic diagnostic device is typically portable and capable of being hand held. However, sometimes additional external devices, such as a probe may be attached to the diagnostic device and thus, the technician's hands may not be available to hold the diagnostic device. The technician may simply place the diagnostic device on the motorcycle in order to use the probe. However, the diagnostic device may fall off and be damaged because it was not secured. Additionally, the diagnostic device's housing can be made of a material, such as an alloy, metal or plastic that can scratch the paint of the motorcycle.

Accordingly, it is desirable to provide a cover that can attach the diagnostic device to the motorcycle and protect the diagnostic device from damaging the paint of the motorcycle.

### SUMMARY OF THE INVENTION

The foregoing needs are met, to a great extent, by the present invention, wherein in one aspect a protective boot is provided around a vehicle diagnostic tool. The protective boot prevents the diagnostic tool from damaging a vehicle to which the tool is attached to.

In accordance with one embodiment of the present invention, a protective boot for a vehicle diagnostic device is provided, which can include a housing for covering the vehicle diagnostic device, the housing is configured to prevent the vehicle diagnostic device from damaging a surface of a vehicle to which the device is attached, a strap receiving member integral with the housing and receives a securing member therethrough, the securing member is configured to mate the protective boot to the surface of the vehicle, a gripping member integral on an outer surface of the housing that allows a user to grip the protective boot, a pair of support feet coupled to the housing and configured to prevent the vehicle diagnostic device from touching a floor, and an off-setting foot on a back surface of the housing to off-set the housing from the surface of the vehicle.

In accordance with another embodiment of the present invention, a protective boot for a vehicle diagnostic device is provided, which can include a housing means for covering the vehicle diagnostic device, the housing means is configured to prevent the vehicle diagnostic device from damaging a surface of a vehicle to which the device is attached, a strap receiving means for receiving a securing means therethrough, the securing means is configured to mate the protective boot to the surface of the vehicle, wherein the strap receiving means is integral with the housing means, a gripping means for allowing a user to grip the protective boot, wherein the gripping means is integral on an outer surface of the housing means, a pair of support means coupled to the housing means and configured to prevent the vehicle diagnostic device from touching a floor, and an off-setting means on a back surface of the housing means to off-set the housing means from the surface of the vehicle.

In accordance with yet another embodiment of the present invention, is a method of securing a vehicle diagnostic device which can include stretching an elastomeric housing around the vehicle diagnostic device, wherein the housing prevents the vehicle diagnostic device from damaging a surface of a vehicle to which the device is attached, feeding a securing member through a strap receiving member that is integral with the housing, and securing the housing with the vehicle diagnostic device to a vehicle with the securing member.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the concept upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a plan front view of a protective boot according to an embodiment of the invention.

FIG. 2 illustrates a plan rear view of a protective boot according to an embodiment of the invention.

FIG. 3 illustrates exemplary positions of the protective boot on a motorcycle.

### DETAILED DESCRIPTION

The invention will now be described with reference to the drawing figures, in which like reference numerals refer to like parts throughout. An embodiment in accordance with the present invention provides a protective cover that can fasten to a vehicle, such as a motorcycle and protect the motorcycle from being damaged by the housing. A person skilled in the art will recognize that the invention can be used with any vehicle including, but not limited, automobiles, trucks, all-terrain-vehicles, and boats.

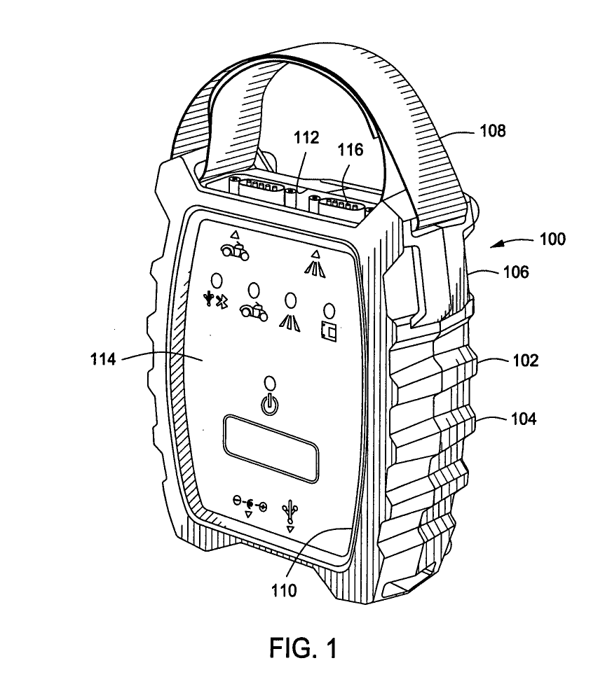

FIG. 1 is a plan front view of a protective boot 100 according to an embodiment of the invention. The protective boot 100 includes a housing 102, a fastening strap 108, and strap receiving member 106. The housing 102 can be made from any elastomeric material such as natural rubber, polyisoprene, butyl rubber, halogenated butyl rubbers, polybutadiene, styrene-butadiene, nitrile rubber, hydrated nitrile rubbers, chloroprene rubber, polychloroprene, neoprene, ethylene propylene rubber, ethylene propylene diene rubber, epichlorohydrin rubber, polyacrylic rubber, silicone rubber, fluorosilicone rubber, fluoroelastomers, perfluoroelastomers, tetrafluoro ethylene/propylene rubbers, chlorosulfonated polyethylene, ethylene-vinyl acetate, thermoplastic elastomers, thermoplastic vulcanizates, polyurethane rubber, and other elastomeric materials.

The housing 102 can also include gripping protrusions 104 along its outer surface. The protrusions help the technician to better grip the housing 102 and provide additional protection. In one embodiment, the gripping protrusions 104 include “peaks” and “valleys” or castling in order to form better gripping surfaces than “flat” gripping surfaces.

The housing 102 can be made from any material (including the ones described above) such that it covers a diagnostic device 114 and prevents the housing or other parts of the diagnostic device from damaging or scratching a surface of the motorcycle. The housing 102 is constructed and designed to be able to be stretched and snapped onto the diagnostic device. With this functionality, the protective boot 100 can be custom fitted to the diagnostic device and can be easily removed or installed on the diagnostic device. Once encased, the housing 102 will protect the motorcycle from being damaged by the housing of the diagnostic device including any protrusions, such connectors 116.

An example of the diagnostic device is a Harley Davidson VCI (vehicle connector interface) from Service Solutions, a unit of the SPX Corporation of Charlotte, N.C. However, the protective boot 100 can be installed on any diagnostic device desired by the user.

The fastening strap 108 is used in conjunction with the strap receiving member 106 to fasten the housing along with the diagnostic device 114 to the motorcycle. The fastening strap can be Velcro, rope, string, nylon, bungee cord or any other fastening means. The fastening strap inserts into the strap receiving member 106 in order to secure the protective boot to the motorcycle. There can be as many strap receiving members 106 as needed. The more strap receiving members on the surface of the housing 102, the more options of securing the protective boot are possible, in particular if the desired placement of the diagnostic device is at a particular difficult location on the motorcycle.

The housing 102 in FIG. 1 also includes openings 110 and 112 to provide user access to the diagnostic device. For example, opening 110 can allow the user to interact with a user interface (not shown), power button or view indicators on the diagnostic device. Opening 112 can allow the user access to connectors 116 that are available on the diagnostic device, such as USB (universal serial bus), serial ports and the like. Additional openings can include openings (backside and bottom) on a side opposite of openings 110 and 112. There can be as many openings as desired by the user in order to provide access to the encased diagnostic device.

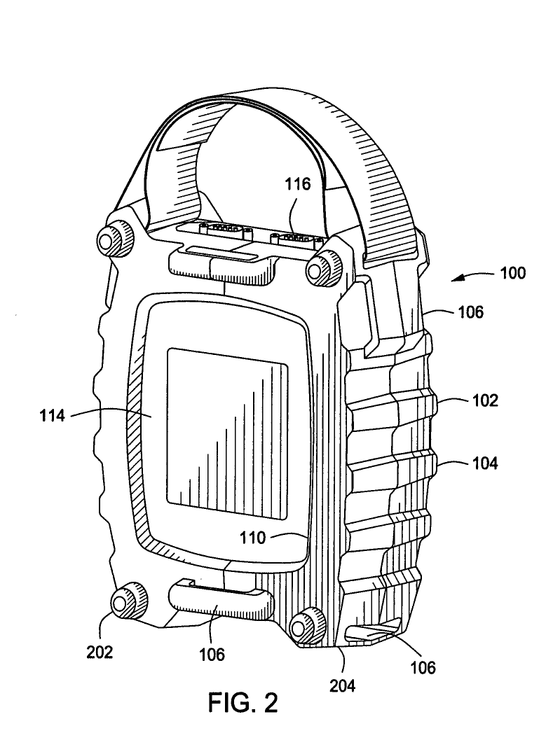

FIG. 2 illustrates a plan rear view of a protective boot 100 according to an embodiment of the invention. This view shows additional strap receiving members 106 for easy installation of the boot 100 to the motorcycle. The housing 102 further include off-setting foot 202 on its rear portion. The off-setting foot off-sets the protective boot 100 from the surface of the motorcycle. Thus, if any portion of the diagnostic device 114 protrudes from opening 110, the off-setting foot 202 can prevent that portion from damaging the motorcycle. In this embodiment, FIG. 2 illustrates four off-setting feet 202 at each corner of the rear portion of the housing, however, as many or as little as 1 or 2 off-setting feet 102 are sufficient to protect the motorcycle from being damaged by the diagnostic device 114. Further, the off-setting foot 202 can be made from the same or different elastomeric material as the housing 102.

The strap receiving member 106 along the sides of the housing 102 includes an outer surface that is further away from the housing 102 than an outer surface of the gripping protrusions 104.

FIG. 2 further illustrates a pair of support feet 204. The support feet 204 are designed to stabilize the protective boot 100 when it is set down on the garage floor. The support feet also keeps the diagnostic device from being susceptible to damage or being damaged by any fluids that may be present when the diagnostic tool is placed on the garage floor. The support feet 204 also includes strap receiving member 106 therein.

In another embodiment, the housing 102 does not include the off-setting foot 202, but rather the strap receiving members 106 keep the rear portion of the housing 102 off of the motorcycle. In this embodiment, as many or as little as 1 or 2 strap receiving members is sufficient to protect the motorcycle from being damaged by the diagnostic device 114.

In another embodiment, the protective boot 100 can be constructed and designed to prevent damage to the diagnostic device 114 when it is dropped from a distance off of the garage floor. Because the protective boot is made from an elastomeric material, the elastomeric material can absorb some or all of the shock of the diagnostic device hitting the floor. Additionally, the protrusions 104 further help to absorb the shock because it is off-set from the rest of the protective boot 100.

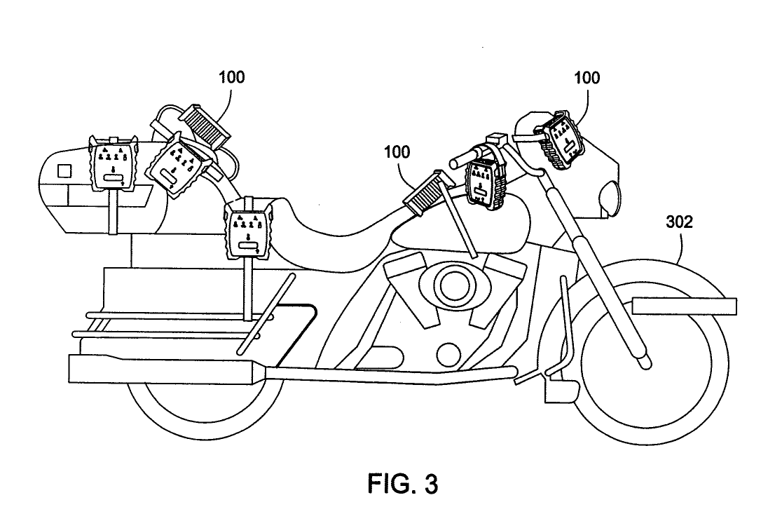

FIG. 3 illustrates exemplary positions of the protective boot 100 on the motorcycle. The protective boot and protected diagnostic device can be placed virtually anywhere on the motorcycle 302. With the various features of the protective boot 100 described above, placement of the diagnostic device on the motorcycle can occur without the worry of the diagnostic device damaging the motorcycle.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A protective boot for a vehicle diagnostic device, comprising:
a housing for covering the vehicle diagnostic device, the housing is configured to prevent the vehicle diagnostic device from damaging a surface of a vehicle to which the device is attached;
a strap receiving member integral with the housing and receives a securing member therethrough, the securing member is configured to mate the protective boot to the surface of the vehicle;
a gripping member integral on an outer surface of the housing that allows a user to grip the protective boot;
a pair of support feet coupled to the housing and configured to prevent the vehicle diagnostic device from touching a floor; and
an off-setting foot on a back surface of the housing to off-set the housing from the surface of the vehicle.

2. The protective boot of claim 1, wherein the gripping member has a castling configuration.

3. The protective boot of claim 1, wherein the housing is made from an elastomeric material.

4. The protective boot of claim 3, wherein the elastomeric material is chosen from one of the following rubber, polyisoprene, polybutadiene, neoprene, styrene-butadiene, and ethylene-vinyl acetate.

5. The protective boot of claim 1, wherein the housing includes openings for access to the vehicle diagnostic device.

6. The protective boot of claim 1, wherein the strap receiving member has an outer surface that is further away from the housing than an outer surface of the gripping member.

7. The protective boot of claim 6, wherein the pair of support foot includes the strap receiving member therein.

8. The protective boot of claim 1, wherein the pair of support foot includes the strap receiving member therein.

9. The protective boot of claim 1, wherein the securing member is a Velcro or a bungee cord.

10. The protective boot of claim 1, wherein there are four off-setting feet at each corner on the back surface of the housing.

11. A protective boot for a vehicle diagnostic device, comprising:
a housing means for covering the vehicle diagnostic device, the housing means is configured to prevent the vehicle diagnostic device from damaging a surface of a vehicle to which the device is attached;
a strap receiving means for receiving a securing means therethrough, the securing means is configured to mate the protective boot to the surface of the vehicle, wherein the strap receiving means is integral with the housing means;
a gripping means for allowing a user to grip the protective boot, wherein the gripping means is integral on an outer surface of the housing means;
a pair of support means coupled to the housing means and configured to prevent the vehicle diagnostic device from touching a floor; and
an off-setting means on a back surface of the housing means to off-set the housing means from the surface of the vehicle.

12. The protective boot of claim 11, wherein the gripping means has a castling configuration.

13. The protective boot of claim 11, wherein the housing means is made from an elastomeric material.

14. The protective boot of claim 11, wherein the housing means includes openings for access to the vehicle diagnostic device.

15. The protective boot of claim 11, wherein the strap receiving means has an outer surface that is further away from the housing means than an outer surface of the gripping means.

16. The protective boot of claim 15, wherein the pair of support means includes the strap receiving means therein.

17. The protective boot of claim 11, wherein the pair of support means includes the strap receiving means therein.

18. The protective boot of claim 11, wherein the securing means is a Velcro or a bungee cord.

19. The protective boot of claim 11, wherein there are four off-setting means at each corner on the back surface of the housing means.

20. A method of securing a vehicle diagnostic device, comprising:
stretching an elastomeric housing around the vehicle diagnostic device, wherein the housing prevents the vehicle diagnostic device from damaging a surface of a vehicle to which the device is attached;
feeding a securing member through a strap receiving member that is integral with the housing; and
securing the housing with the vehicle diagnostic device to a vehicle with the securing member.
